(19) United States
(12) Patent Application Publication
(10) Pub. No.: US 2006/0153621 A1
(43) Pub. Date: Jul. 13, 2006

(54) Method and apparatus for substrate handling and printing

(76) Inventor: Howard John Manning, Edinburgh (GB)

Correspondence Address: FLESHNER & KIM, LLP, P.O. BOX 221200, CHANTILLY, VA, 20153, US

(21) Appl. No.: 10/529,363

(22) PCT Filed: Sep. 25, 2003
(86) PCT No.: PCT/GB03/04166

§ 371 Date: Nov. 18, 2005

(30) Foreign Application Priority Data
Sep. 27, 2002 (GB) 0222397.2

(51) Int. Cl. B41J 13/10

(52) U.S. Cl. 400/625

(57) ABSTRACT

An apparatus and method are described for transferring substrates to and from a printer. In a described embodiment, the apparatus includes a pair of storage units for vertically stacking substrates, and a laterally moveable platen. The storage units are moveable vertically with respect to the platen in order to transfer substrates to and from the platen. The apparatus and method have particular application in the handling and printing large numbers of biological samples on glass slides.

The present invention relates to the field of printing, and in particular to the printing of large number of substrates.

Ink jet printheads can be used to position spots of liquids, for example biological samples, on substrates such as glass slides. An important application-of this technique is the manufacture of DNA microarrays.

When manufacturing a microarray, it is normally required to print one, two, three or more spots of each liquid onto each of a large number (tens to hundreds) of substrates. Typically, there will be a very large number (hundreds to tens of thousands) of different liquids to be printed onto the substrates, so the printing process may be lengthy.

The cleaning of the printhead before the introduction of the next set of liquids takes time, and therefore the once a set of liquids has been introduced into the printhead, they should be printed onto all the slides before another set of liquids is loaded.

Patent application WO 02/11889 discloses a method whereby an ink jet printhead having multiple chambers, each associated with a nozzle, can be used to print multiple different liquids at the same time. The printing can be carried out without cross-contamination between the liquids, despite the fact that the chambers are connected by one or more manifolds internal to the printhead. The liquids are introduced via contiguous groups of nozzles into the associated chambers and printed before they have time to mix by diffusion. Handling multiple liquids therefore offers the possibility of reducing the time taken to do the considerable amount of printing required in the production of DNA microarrays.

However, if a large number of slides is to be printed, their area is too large to allow them to be arranged in a plane -for easy access during printing. It is therefore only practical to arrange smaller groups of the slides for printing. Since the slides do not occupy much volume, it is convenient to store the slides in a multilayer stack. However, the transfer into and out of storage inevitably occupies some time, conflicting with the need to minimise manufacturing time.

It would therefore be desirable to provide a method and apparatus for handling and printing substrates that obviated or at least mitigated some of the drawbacks of conventional systems.

It is one aim of an aspect of the invention to provide a method for loading and unloading substrates to printing apparatus in an efficient and rapid manner.

It is a second aim of an aspect of the invention to provide apparatus for loading and unloading substrates to printing apparatus in an efficient and rapid manner.

Further aims and objects of the invention will become apparent from a reading of the description.

According to a first aspect of the invention, there is provided apparatus for transferring substrates to and from a printer, comprising:
a first storage unit for storing substrates prior to a printing operation, the first storage unit having a plurality of vertically stacked substrate supports;
a platen for receiving a substrate from said first storage unit, aligning the substrate with a printhead prior to a printing operation, and displacing the substrate subsequent to a printing operation to an unloading position;
a second storage unit for storing substrates subsequent to said printing operation, the second storage unit having a plurality of vertically stacked substrate supports;
wherein the first and second storage units are movable vertically with respect to the platen, and in use, relative vertical movement of the first storage unit and the platen transfers a substrate from the supports of the first storage unit to the platen, and relative vertical movement of the second storage unit and the platen transfers a substrate from the platen to the supports of the second storage unit.

Preferably, the vertically stacked substrate supports of the first and second storage units are arranged to support substrate-handling trays for holding a plurality of substrates.

Preferably, the platen receives a substrate-handling tray from the first storage unit, the substrate being held on said substrate handling tray.

The substrate handling tray may extend lengthways across the width of the platen, the length of the tray being greater than the width of the platen.

Preferably, the first and second storage units are frames defining an interior cavity, into which the platen extends.

According to a second aspect of the invention, there is provided a method for transferring substrates to and from a printer, comprising the steps of:
imparting relative vertical movement between a first storage unit for storing substrates and a platen, the first storage unit having a plurality of vertically stacked substrate supports, thereby transferring a substrate from the supports of the first storage unit to the platen;
aligning the substrate with a printhead;
printing on the substrate;
displacing the substrate to an unloading position;
imparting relative vertical movement between a second storage unit for storing substrates and the platen, the second storage unit having a plurality of vertically stacked substrate supports, thereby transferring a substrate from the platen to the supports of the second storage unit.

According to a third aspect of the invention, there is provided a method for printing substrates on a platen, the method comprising the steps of:
printing a substrate by imparting linear movement to the printhead, thereby causing the printhead to traverse the substrate in a first direction, whilst simultaneously transferring a further substrate between the platen and a substrate storage unit;
aligning the second substrate tray with the printhead, whilst reversing the direction of motion of the printhead;
printing the substrates held on a second substrate tray by imparting linear movement to the printhead, thereby causing the printhead to traverse the substrates in a second direction opposite to the first.

Preferably, the transfer of a substrate between the platen and the substrate storage unit is carried out by imparting relative vertical movement between a substrate storage unit and the platen, the storage unit having a plurality of vertically stacked substrate supports.

According to a fourth aspect of the invention, there is provided a method for printing substrates on a platen, the method comprising the steps of:
printing a substrate by imparting linear movement to the printhead, thereby causing the printhead to traverse the substrate in a first direction;
transferring a further substrate between the platen and a substrate storage unit;
aligning the further substrate with the printhead, whilst reversing the direction of motion of the printhead;
printing the substrates held on a second substrate tray by imparting linear movement to the printhead, thereby causing the printhead to traverse the substrates in a second direction opposite to the first.

According to a fifth aspect of the invention, there is provided a method for printing substrates on a platen, the method comprising the steps of:
printing a substrate by imparting linear movement to the printhead, thereby causing the printhead to traverse the substrate in a first direction, whilst simultaneously transferring a further substrate between the platen and a substrate storage unit;
aligning the second substrate tray with the printhead;
reversing the direction of motion of the printhead;
printing the substrates held on a second substrate tray by imparting linear movement to the printhead, thereby causing the printhead to traverse the substrates in a second direction opposite to the first.

Preferably, the steps of the method are repeated.

There will now be described, by way of example only, various embodiments of the invention with reference to the following drawings, of which:

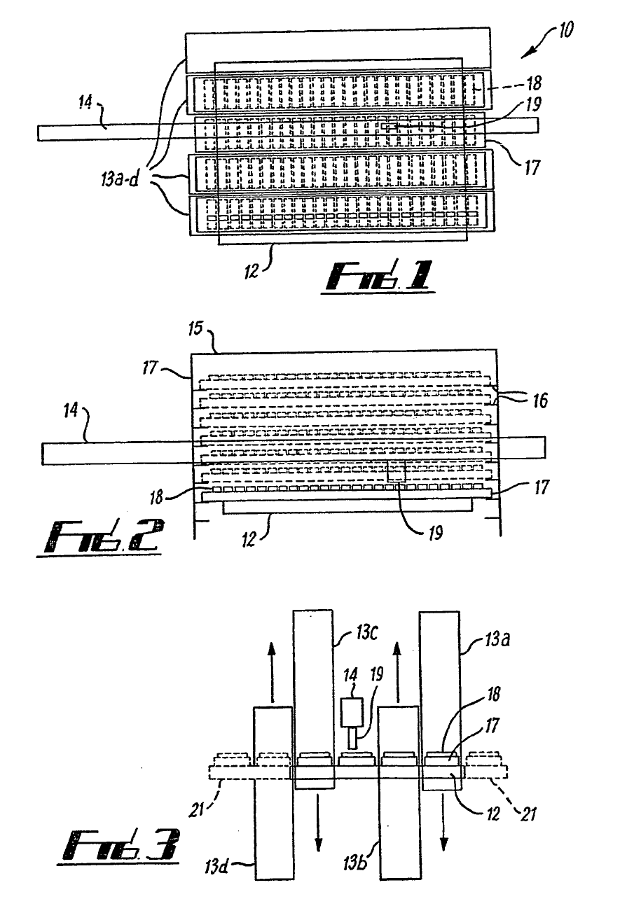

FIG. 1 is a plan view of apparatus according to an embodiment of the invention;

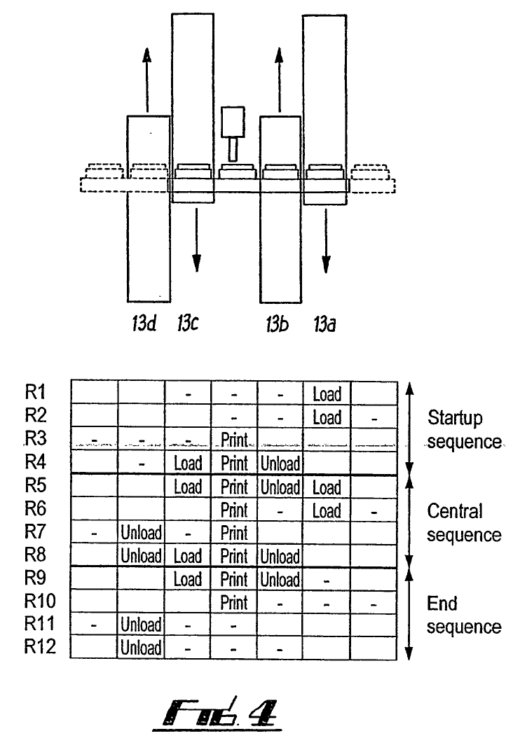

FIG. 2 is a front view of the apparatus of FIG. 1;

FIG. 3 is a side view of the apparatus of FIG. 1;

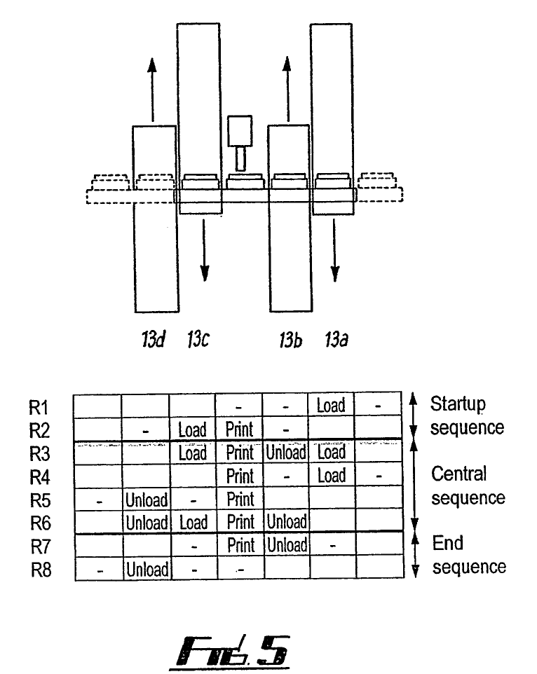

FIG. 4 shows a side view of the apparatus and a table useful for explaining a method in accordance with an embodiment of the invention;

FIG. 5 shows a table useful for explaining a method in accordance with an alternative embodiment of the invention.

Referring firstly to FIGS. 1 and 2, the apparatus generally depicted at 10 includes a platen 12, four cages 13a to 13d, and a linear rail 14. Each cage is a rectangular metal frame 15 having a series of vertically stacked substrate supports in the form of inwardly protruding ledges 16. The cages are shaped to receive a number of slide trays 17, each slide tray holding a linear array of slides to be printed. Each slide tray 17 is oriented lengthways across the width of the platen 12, and the length of the trays is greater than the width of the platen. The platen 12 is therefore able to extend into a central cavity defined by the frame of the cage. The platen 12 has four positions for receiving slide trays. Above one of the positions is a linear rail 14 along which the printhead 19 can be moved in a reciprocating motion following a trapezoidal velocity profile. The acceleration and deceleration associated with the changing of direction of the printhead at each end occurs beyond the end of the trays. The printhead axis is positioned with two cages 13 on either side. A suitable printhead is the XaarJet XJ126R.

The arrangement for the slides within a tray is a linear array of, say, twenty five slides 18 with their short edges parallel to the long axis of the trays and the long edges of adjacent slides facing one another. This minimises the time occupied travelling over each slide. A convenient pitch for the slides is 27 mm, which allows space for mechanisms to hold the slides, and fits in with the possibility of using two or more printheads, line astern. A printhead such as the XaarJet XJ126R can be set at a pitch of 54 mm, which works well with the 9 mm pitch of the well-plates from which the liquids are usually obtained.

As shown in FIG. 2 ledges 16 of the cages above the platen 12 are filled with trays 17 (all but one shown in dotted lines for clarity), while the ledges below are empty. The cage is shown in a position where it has moved downwards, so that the tray is brought into contact with the platen. A slight further downward movement of the cage causes the tray to come to rest on the platen, freeing the trays from the ledges of the cage on which it was resting and depositing it onto the platen. A subsequent fore-aft movement of the platen will carry the tray to a position outside the frame of the cage.

FIG. 3 shows the four cages 13a to 13d from a side view. Cages 13a and 13c are loaded with slide trays (not shown), and are positioned above the platen. In use, these upper cages will descend in stages from the high positions, depositing trays onto the platen in readiness for printing. In contrast, cages 13b and 13d are empty of trays, and are initially located in low positions below the platen. Cages 13b and 13d ascend from these low positions, unloading trays from the platen after printing.

The platen 12 is shown in one of its four possible positions, in which it spans four of seven equally sized regions of space. The other positions are shown by dotted lines 21. The two extreme positions are outside of the boundary of the cages 13.

The operation of the apparatus will now be described with reference to FIG. 4. The Figure shows the apparatus from a side view, and a table useful for understanding the handling and printing process.

Each row of the table represents a different time interval during the process. Time passes from the top of the table to the bottom. The first four rows represent a start-up sequence for loading and printing the first trays, and the bottom four rows represent an end sequence for dealing with the last trays. The middle four rows are repeated for as many iterations as is necessary for printing the entire batch of slides.

Each column of the table corresponds to a possible position of the platen. The platen occupies four adjacent positions within the seven. The actual position of the platen at any time is indicated by the shaded portions of the table.

The apparatus is initially set up as follows: the two cages 13a, 13b are in their uppermost positions, fully occupied by trays of slides; cages 13b, 13d are in their lowest positions, empty. The platen is initially empty.

First a startup sequence is performed, as represented by rows R1 to R4 of FIG. 4:

The platen is positioned as illustrated, occupying the third to sixth of the seven regions (counting from the left). The first tray is loaded onto the platen by a downward movement of the right-most cage, cage 13a. As described above, the downward movement of the cage causes the tray to come to rest on the platen, freeing the tray from the ledges of cage 13a and depositing it onto the platen. This action is represented by the word ‘load’ in the table, underneath the cage in question.

The platen then moves one pitch to the right placing the tray outside the frame and ledges of cage 13a. A second tray is loaded by cage 13a to a platen position adjacent to the first tray.

The platen then moves three pitches to the left, so that it occupies the first to fourth positions. Next, the printhead performs its first movement, printing the slides located on the first tray (now located under the printhead rail). This action is represented by the word ‘print’ underneath the printhead in the table of FIG. 4 at row R3.

When the printhead has passed the end of the slide tray, the printhead slows down and changes direction. While the printhead is turning round, the platen moves one pitch to the right. The printhead now prints the second of the trays, while moving in the reverse direction. Simultaneously, while the printhead is moving but the platen is stationary, the cage 13c loads a third tray. At the same time, cage 13b unloads the first tray that was printed. This unloading action is effectively the reverse of the loading action. The cage 13c surrounds the tray as it rests on the platen, and the ledges are located underneath the ends of the tray. The cage 13b moves upwards, so that the ledges are brought into contact with the tray, and then lift the tray from the platen. This unloading action is represented in the table of FIG. 4 is ‘unload’.

The platen moves one pitch to the right, completing the start-up sequence, and the system enters a central sequence that is repeated as often as is appropriate for the number of trays in the machine.

The central sequence follows the same principle. Cages 13 load and unload trays during printing and when the platen 12 is stationary. The platen moves while the printhead is reversing direction. The central sequence shown, consists of four stages, represented by rows R5 to R8. The apparatus first load 3 two trays 5 from cages 13a and 13c, unloads one tray onto cage 13b, and prints the tray that is aligned with the printhead. The following two steps respectively involve a print operation and the loading of a new tray from cage 13a, and print operation and an unloading action onto cage 13d. The central sequence therefore prints four trays in four traverses of the printhead. That is, the printhead is busy at every step of the process. The central sequence is repeated as many times as necessary, until the cages 13a and 13c are almost empty of trays.

Rows R9 to R12 represent an end sequence for handling the remaining trays on the platen 12. At R9, the final tray is loaded onto the platen form cage 13d, the penultimate tray is printed, and a tray is unloaded onto cage 13b. The next steps involves the printing of the final tray, and the subsequent unloading of the trays onto cage 13d.

The whole of the above-described operation consists of a start-up sequence, a number n of repeats of the four-stage central sequence, and an end sequence. The operation results in the printing of a set of liquids held within the printhead onto all 4(n+1) trays of slides in the machine. At the end of this operation the trays have been transferred, with reversal of order, from the two loading cages 13a, 13c to the two unloading cages 13b, 13d. Cages 13a, 13b were initially in a raised position, but have now descended below the platen, emptying of trays. Cages 13b, 13d, initially below the platen, have ascended filling with trays.

It is notable that only four out of a total of 4(n+2) operations do not involve printing, so the printhead is kept busy with great efficiency, particularly if n is substantial.

When the next set of liquids has been acquired by the printhead, the entire operation is applied in reverse, printing the new set of liquids onto slightly different positions on all the trays of slides. The load cages 13a, 13c, which were moving downwards, have now become unload cages moving upwards, and vice versa. The scheme illustrated in the table of FIG. 4 has the highly desirable property that every tray is printed with the printhead travelling in the same direction as with the previous set of liquids. This minimises errors due to the time of flight of the drops, as the shifts will in the same direction for all liquids printed onto a given slide. At the end of two complete operations, two sets of liquids have been printed onto all of the slides, and all the cages and trays are back in their original positions.

Multiple sets of liquids are printed using the same overall operation, alternately in the order given in FIG. 4 and in reverse. The positions on the slides of the sets of spots are shifted in the direction of printhead motion by applying different offsets to the triggering electronics each time the printhead performs a series of traverses. After a number of operations, the slides have been filled with spots along the line of travel of the printhead. During the next few operations, the four positions visited by the platen, while still equally spaced at the same pitch, are shifted slightly relative to the previous ones. This causes another row of spots to be printed on the slides. It is necessary for the entire assembly of four cages to occupy a slightly different position for each row of spots. As printing of a large number of liquids proceeds, multiple rows of spots are produced on the slides. Their spacing in the direction of printhead travel is controlled by the timing of printhead triggering, and the spacing perpendicular to printhead motion is determined by the shifts in platen positions. Accuracy of spot positioning is guaranteed by the accuracy of these two motions and by the mechanism whereby trays stored on inaccurately manufactured cages are located precisely on the platen as they are loaded.

The sequence in the table of FIG. 4 prints 4(n+1) trays of slides. If the number of trays to be printed is even but not divisible by four, i.e. 4n+2, the sequence shown in the table of FIG. 5 can be used. This sequence appears to be slightly more efficient than that in the table of FIG. 4, in that one fewer stage is required at start-up and at the end. However, as explained above, it is highly desirable to guarantee that individual slides are always printed with printhead motion in the same direction. The sequence of FIG. 5 will require an extra traverse by the printhead at the outset, and at the end in order for the printhead motion to be consistent.

It is possible to extend these schemes to handle an odd number of trays or to handle the situation where the last tray is not filled with slides. Thus, any number of slides can be handled, not just a multiple of fifty.

Other schemes are possible, involving cages which load more than one tray at a time onto the platen; using two or more than four cages; using cages to store both unprinted and printed trays.

A practical convenience of the proposed four-cage system is that at the outset the two cages closest to the front of the machine can be loaded with trays, and the platen used to transfer the contents of one of them to the rear of the machine as required to start the sequences of FIG. 4.

The present invention provides an efficient means of printing a large number of substrates, by providing a rapid means of storing, retrieving, printing and re-storing slides.

The arrangement reduces the requirement for reloading the printhead with different liquids. The liquids are valuable and available in small quantities only. The loading of liquids into the printhead is inevitably wasteful in that only a proportion of each liquid is usefully printed. Ink jet printheads produce very small drops, so once liquids are introduced into the printhead, it can print a very large number of spots. The present invention utilises this characteristic of the printheads effectively.

A further advantage of the invention arises from reciprocating the printhead motion using a one-dimensional transport, and mounting multiple trays on a platen which is capable of movement at right-angles to the printhead motion. The printhead traverses to print the tray which is in the appropriate position on the (stationary) platen; then the platen moves laterally while the printhead is turning round at the end of its stroke, bringing another tray of slides into position underneath the axis of printhead motion. By the time the next printhead stroke takes place, the platen is again stationary. Accurate spot positioning is achieved in the direction of printhead travel by timing of the drop ejection, as disclosed in patent application WO 02/11889, and in the perpendicular direction by precise positioning of the platen.

The invention therefore minimises the time during which the printhead is not printing.

An additional advantage of this approach is that larger numbers of trays can be printed than those which fit on the platen: one or more cages can be used to store the trays when they are not being printed, to feed them onto the platen for printing and to remove them afterwards. A number of trays can be stored above each other on shelves in each cage; one or more cages can be moved vertically downwards so as to deposit the trays in turn onto the platen in preparation for printing. One or more other cages, moving vertically upwards, can remove them afterwards. The cages can perform these functions while the platen is stationary, during the printing stroke of the printhead. Thus the loading of trays onto the platen and unloading from it need not add to the time taken to print the overall number of slides in the machine; this scheme is equivalent in speed to a system using an impracticably large platen to hold all the trays.

A further advantage of this approach is that the cages and their motion need not be precise: if the trays are equipped with location features which engage with matching features on the platen, the act of loading each tray onto the platen ensures its accurate positioning with respect to the platen. The only parameters that need to be accurate are the printhead mounting, its motion, the platen's location features and its motion. Both of these motions are one-dimensional.

It will be evident to the skilled reader that various changes could be made to the above-described embodiments within the scope of the invention. For example, different numbers of loading and unloading cages could be employed. In addition, one cage could unload trays, and could reload the same trays from the platen after printing. A further arrangement may utilise two cages that simultaneously unload or load two trays at different positions on the platen.

Various modifications and improvements can be made within the scope of the invention herein intended.

1. Apparatus for transferring substrates to and from a printer, comprising:
a first storage unit for storing substrates prior to a printing operation, the first storage unit having a plurality of vertically stacked substrate supports;
a platen for receiving a substrate from said first storage unit, aligning the substrate with a printhead prior to a printing operation, and displacing the substrate subsequent to a printing operation to an unloading position;
a second storage unit for storing substrates subsequent to said printing operation, the second storage unit having a plurality of vertically stacked substrate supports;
wherein the first and second storage units are movable vertically with respect to the platen, and in use, relative vertical movement of the first storage unit and the platen transfers a substrate from the supports of the first storage unit to the platen, and relative vertical movement of the second storage unit and the platen transfers a substrate from the platen to the supports of the second storage unit.

2. Apparatus as claimed in claim 1, wherein the vertically stacked substrate supports of the first and second storage units are arranged to support substrate trays for holding a plurality of substrates.

3. Apparatus as claimed in claim 2, wherein the platen receives a substrate tray from the first storage unit, the substrate being held on said substrate tray.

4. Apparatus as claimed in claim 2, wherein a substrate tray extends lengthways across the width of the platen, the length of the tray being greater than the width of the platen.

5. Apparatus as claimed in claim 1, wherein the first and second storage units comprise frames defining an interior cavity, into which the platen extends.

6. Apparatus as claimed in claim 1, further comprising third and fourth storage units movable vertically relative to the platen.

7. Apparatus as claimed in claim 6 wherein two of said storage units are arranged on a first side of the printhead, and two of said storage units are arranged on the opposing side of the printhead.

8. A method for printing substrates on a platen, the method comprising the steps of:
printing a first substrate by imparting linear movement to the printhead, thereby causing the printhead to traverse the first substrate in a first direction;
aligning a second substrate with the printhead, whilst reversing the direction of motion of the printhead;
printing the second substrate by imparting linear movement to the printhead, thereby causing the printhead to traverse the second substrate in a second direction opposite to the first.

9. The method as claimed in claim 8 wherein the substrates are aligned by imparting relative lateral movement between the platen and the printhead.

10. The method as claimed in claim 8 comprising the additional step of transferring the second substrate to the platen from a substrate storage unit.

11. The method as claimed in claim 10 wherein the step of transferring the second substrate to the platen is carried out simultaneously with the printing of the first substrate.

12. The method as claimed in claim 8 wherein the step of aligning the second substrate with the printhead also aligns the first substrate with a substrate storage unit.

13. The method as claimed in claim 8 comprising the additional step of transferring the first substrate from the platen to a substrate storage unit.

14. The method as claimed in claim 13 wherein the step of transferring the first substrate from the platen to a substrate storage unit is carried out simultaneously with the printing of the second substrate.

15. The method as claimed in claim 10 wherein the transfer of a substrate between the platen and the substrate storage unit is carried out by imparting relative vertical movement between a substrate storage unit and the platen.

16. A method for printing substrates on a platen, the method comprising the steps of:
printing a first substrate whilst simultaneously transferring a further substrate between the platen and a substrate storage unit;
aligning the further substrate with the printhead;
printing the further substrate.

17. The method as claimed in claim 16 wherein the first substrate is printed by causing the printhead to traverse the substrate in a first direction, the further substrate is printed by causing the printhead to traverse the further substrate in a second direction opposite to the first, and the step of aligning the further substrate with the printhead is carried out whilst reversing the direction of motion of the printhead.

18. The method as claimed in claim 16 wherein the step of aligning the further substrate with the printhead also aligns the first substrate with a substrate storage unit.

19. The method as claimed in claim 16 wherein the substrates are aligned by imparting relative lateral movement between the platen and the printhead.

20. The method as claimed in claim 16 comprising the additional step of transferring the first substrate from the platen to a substrate storage unit.

21. The method as claimed in claim 20 wherein the step of transferring the first substrate from the platen to a substrate storage unit is carried out simultaneously with the printing of the further substrate.

22. The method as claimed in claim 16 wherein the transfer of a substrate between the platen and the substrate storage unit is carried out by imparting relative'vertical movement between a substrate storage unit and the platen.

23. A method for printing substrates on a platen, the method comprising the steps of:
printing a substrate by imparting linear movement to the printhead, thereby causing the printhead to traverse the substrate in a first direction, whilst simultaneously transferring a further substrate between the platen and a substrate storage unit;
aligning the further substrate with the printhead while reversing the direction of motion of the printhead;
printing the further substrate by imparting linear movement to the printhead, thereby causing the printhead to traverse the substrate in a second direction opposite to the first.

24. The method as claimed in claim 16 wherein the substrates are mounted on substrate trays.

25. The method as claimed in claim 24 wherein the first substrate is one of a set of substrates mounted on a first substrate tray, and the second or further substrate is one of a set of substrates mounted on a second substrate tray.

26. The method as claimed in claim 24 wherein the transfer of substrates to or from the platen is by transfer of substrate trays to or from the platen.

27. The method as claimed in claim 16, wherein the steps of the method are repeated for third and additional substrates or substrate trays.
